(19) United States
(12) Patent Application Publication
(10) Pub. No.: US 2024/0326313 A1
(43) Pub. Date: Oct. 3, 2024

(54) METHOD OF MANUFACTURING EXTRUSION MOLDED PRODUCT

(71) Applicant: Tokiwa Chemical Industries Co., Ltd., Chiba (JP)

(72) Inventors: Takashi Hirokawa, Chiba (JP); Naohisa MIYAKAWA, Chiba (JP)

(21) Appl. No.: 18/390,601

(22) Filed: Dec. 20, 2023

(30) Foreign Application Priority Data
Mar. 29, 2023 (JP) 2023-52565

(51) Int. Cl. B29C 48/92; B29C 48/00

(52) U.S. Cl. CPC B29C 48/92; B29C 48/022

(57) ABSTRACT

A method of manufacturing an extrusion molded product includes a step of pulling a core member by a first puller, the core member being made of a synthetic resin and molded into a desired shape in a first die and a step of pulling the core member, which has been pulled by the first puller, by a second puller and molding an extrusion molded product in which a covering portion made of a thermoplastic elastomer is provided over an outer periphery of the core member in a second die. A sensor unit that monitors tension in the core member is provided between the first puller and the second puller, and at least one of the first puller and the second puller adjusts a pulling speed such that the tension in the core member between the first puller and the second puller falls within a normal range.

### BACKGROUND OF THE INVENTION

### 1. Field of the Invention

The present invention relates to a method of manufacturing extrusion molded products such as weather strips, trims, and seal components that are mounted onto automobiles, two-wheeled vehicles, outboard motors, and the like.

### 2. Description of the Related Art

Regarding core members that are used in extrusion molded products such as weather strips, trims, and seal components to be mounted onto automobiles, two-wheeled vehicles, outboard motors, and the like, the material of such core members has been changed from a metal to a synthetic resin so as to achieve weight reduction and recycling and so as to address environmental issues, metal corrosion, and the like.

In a method of manufacturing an extrusion molded product that uses such a core member made of a synthetic resin, a synthetic resin injected into a first extruder is molded by using a first die into a core member having a desired shape and then cooled in a first cooling tank. After that, first pulling rollers receive the core member and send to a second die, and then, a covering portion, such as a seal portion or a lip portion, that is made of thermoplastic elastomer is provided over the outer periphery of the core member in the second die. In addition, although not illustrated, the core member is received by a second puller so as to pass through a second cooling tank (see, for example, Japanese Patent No. 6589189 and Japanese Patent No. 6005311)

### PRIOR ART DOCUMENTS

Patent Document 1: Japanese Patent No. 6589189
Patent Document 2: Japanese Patent No. 6005311

However, it is difficult to cause the first puller and the second puller to operate at exactly the same speed only by setting the speeds of the first and second pullers, and there has been a problem in that the speed difference between the first and second pullers generates a surplus portion of a core member, which is made of a synthetic resin, forming slack in the core member between the first and second pullers or a problem in that the speed difference creates excessive tension, resulting in overextension of the core member and causing a defect in providing a covering portion made of thermoplastic elastomer over the outer periphery of the core member in the second die, so that the quality of an extrusion molded product eventually manufactured is reduced.

In particular, in the case where a core member is molded in the first die so as to have a desired shape, and then, grooves are formed in the core member as in Japanese Patent No. 6589189 and Japanese Patent No. 6005311 in order to form an easily bendable extrusion molded product, or in the case where an easily bendable core member that is substantially I-shaped when viewed in cross section (that has a flat plate-like shape) is molded in the first die, since the core material is easily bendable, a surplus portion of the core member is likely to be generated due to the speed difference between the first and second pullers forming slack in the core member, or excessive tension is likely to be created due to the speed difference, resulting in overextension of the core member.

### SUMMARY OF THE INVENTION

Accordingly, the present invention has been made to solve the problems described above, and it is an object of the present invention to provide a method of manufacturing an extrusion molded product, the method capable of adjusting a pulling speed such that the tension in a core member, which is made of a resin, between a first puller and a second puller falls within a normal range and capable of preventing deterioration of the accuracy with which an extrusion molded product is molded, degradation of the quality of the extrusion molded product, and so forth.

In order to solve the above problems, a method of manufacturing an extrusion molded product according to the present invention includes a step of pulling a core member by a first puller, the core member being made of a resin and molded into a desired shape in a first die and a step of molding an extrusion molded product by providing a covering portion made of a thermoplastic elastomer over an outer periphery of the core member, which has been pulled by the first puller, in a second die and pulling the extrusion molded product by a second puller. A sensor unit that monitors tension in the core member is provided between the first puller and the second puller, and at least one of the first puller and the second puller adjusts, based on the tension in the core member monitored by the sensor unit, a pulling speed such that the tension in the core member between the first puller and the second puller falls within a normal range.

In the method of manufacturing the extrusion molded product according to the present invention, the sensor unit may include core-member feeding rollers that are arranged between the first puller and the second puller with a gap formed between the core-member feeding rollers in a direction in which the core member is moved and a vertically-movable tension-applying roller that is provided between the core-member feeding rollers in such a manner as to be capable of moving up and down and that applies tension to the core member, and the sensor unit may monitor the tension in the core member based on a height of the vertically-movable tension-applying roller.

In the method of manufacturing the extrusion molded product according to the present invention, a cutting mechanism unit that cuts the core member in such a manner as to form a groove by using a cutting blade may be provided between the first die and the first puller. The sensor unit may apply tension to the core member, in which the groove has been formed by the cutting mechanism unit, in a direction in which the core member is easily bent.

In the method of manufacturing the extrusion molded product according to the present invention, the second puller may pull, based on the tension in the core member monitored by the sensor unit, the extrusion molded product at a pulling speed with an upper limit speed and a lower limit speed each of which is within ±12.5% of a pulling speed of the first puller without stopping.

In the method of manufacturing the extrusion molded product according to the present invention, the first puller may pull, based on the tension in the core member monitored by the sensor unit, the core member at a pulling speed with an upper limit speed and a lower limit speed each of which is within ±12.5% of a pulling speed of the second puller without stopping.

In the method of manufacturing the extrusion molded product according to the present invention, the tension in the core member, which is made of a resin, is monitored by the sensor unit provided between the first puller and the second puller, and at least one of the first puller and the second puller adjusts its pulling speed such that the tension of the core member falls within the normal range. Thus, the tension of the core member falls within the normal range between the first puller and the second puller, and formation of slack in the core member or overextension of the core member will not occur. Therefore, the extrusion molded product in which the covering portion made of a thermoplastic elastomer is provided over the outer periphery of the core member made of a resin can be consistently manufactured, and deterioration of the accuracy with which an extrusion molded product using a core member made of a resin is molded, degradation of the quality of the extrusion molded product, and so forth can be prevented.

### BRIEF DESCRIPTION OF THE DRAWINGS

FIG. 1 is a side view illustrating an example of the entire manufacturing process in a method of manufacturing an extrusion molded product according to an embodiment of the present invention.

FIG. 2 is a diagram illustrating a configuration example of a sensor unit illustrated in FIG. 1.

FIG. 3A is a cross-sectional view of a core member that is made of a synthetic resin and that is molded in a first die, which is illustrated in FIG. 1, so as to have a substantially inverted U-shape when viewed in cross section, and FIG. 3B is a cross-sectional view of a core member that is made of a synthetic resin and that is molded in the first die illustrated in FIG. 1 so as to have a substantially I-shape when viewed in cross section.

FIG. 4 is a diagram illustrating a configuration example of a cutting mechanism unit illustrated in FIG. 1 and illustrating, for example, a state in which grooves are formed in the core member that is illustrated in FIG. 3A and that has a substantially inverted U-shape when viewed in cross section by using the cutting mechanism unit.

FIG. 5 is a diagram illustrating a configuration example of the cutting mechanism unit illustrated in FIG. 1 and illustrating, for example, a state in which grooves are formed in the core member that is illustrated in FIG. 3B and that has a substantially I-shape when viewed in cross section by using the cutting mechanism unit.

FIG. 6 is a diagram illustrating a state in which, in the sensor unit illustrated in FIG. 1, a vertically-movable tension-applying roller reaches an upper limit position β as a result of the tension in the core member exceeding a predetermined range, so that an upper contact sensor is switched on.

FIG. 7 is a diagram illustrating a state in which, in the sensor unit illustrated in FIG. 1, the vertically-movable tension-applying roller reaches a lower limit position γ as a result of the tension in the core member falling below the predetermined range, so that a lower contact sensor is switched on.

FIG. 8 is a diagram illustrating the dimensional tolerance table for rubber molded products (ISO 3302-1 Class M).

FIG. 9 is a cross-sectional view illustrating an example of a weather strip that is manufactured by the method of manufacturing an extrusion molded product according to the embodiment of the present invention (the case of a core member made of a synthetic resin and having a substantially inverted U-shape when viewed in cross section).

FIG. 10 is a cross-sectional view illustrating an example of a weather strip that is manufactured by the method of manufacturing an extrusion molded product according to the embodiment of the present invention (the case of a core member made of a synthetic resin and having a substantially I-shape when viewed in cross section).

FIG. 11 is a diagram illustrating a configuration example in the case where a non-contact sensor, which is, for example, an infrared sensor is used in the sensor unit illustrated in FIG. 1.

FIG. 12 is a diagram illustrating a configuration example in the case where a variable resistance sensor, which is, for example, a potentiometer or the like is used in the sensor unit illustrated in FIG. 1.

### DESCRIPTION OF THE PREFERRED EMBODIMENTS

An embodiment of a method of manufacturing an extrusion molded product according to the present invention will be described in detail below with reference to the drawings. Note that the embodiment that will be described below is merely an example of the present invention. The present invention is not limited to the embodiment, and changes may be suitably made within the technical concept of the present invention.

### Example of Manufacturing Process for Implementing Method of Manufacturing Extrusion Molded Product According to Embodiment

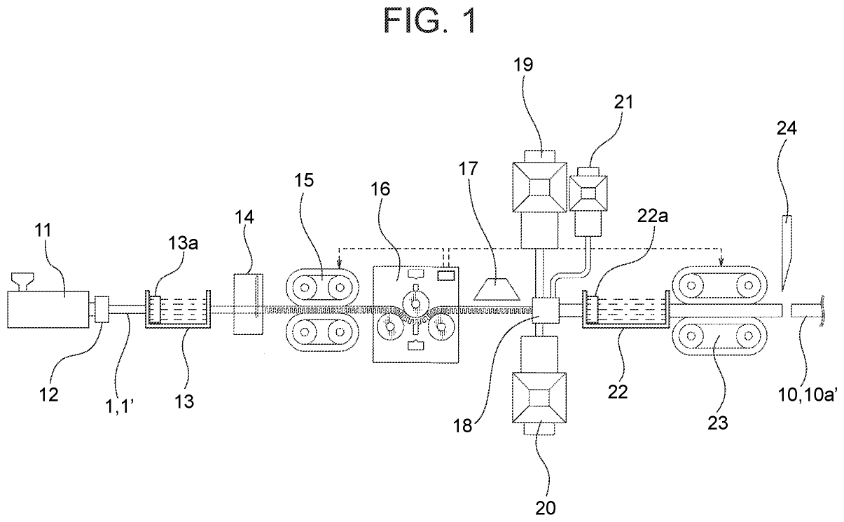

FIG. 1 is a diagram illustrating an example of a manufacturing process for implementing the method of manufacturing an extrusion molded product according to the embodiment of the present invention.

As illustrated in FIG. 1, the manufacturing process for implementing the method of manufacturing an extrusion molded product according to the embodiment of the present invention includes a first extruder 11, a first die 12, a first cooling tank 13, a cutting mechanism unit 14, a first puller 15, a sensor unit 16, a heater 17, a second die 18, a second extruder 19, a third extruder 20, a fourth extruder 21, a second cooling tank 22, a second puller 23, a cutter 24, and so forth.

This manufacturing process has a configuration that is substantially the same as the method of manufacturing an extrusion molded product disclosed in Japanese Patent No. 6589189 and the method of manufacturing an extrusion molded product disclosed in Japanese Patent No. 6005311, which are mentioned above, excluding the sensor unit 16, and thus, only the configuration of the sensor unit 16 will be described in detail. In addition, in the description of the present embodiment, a core member 1 that has a substantially inverted U-shape when viewed in cross section and a core member 1′ that has a substantially I-shape (a flat plate-like shape) when viewed in cross section will be described as example of a core member. However, the core members 1 and 1′ are merely examples, and the present invention is not limited to the core members 1 and 1′. Furthermore, in the case where there is an unnecessary component in the configuration illustrated in FIG. 1, that is, for example, when the heater 17, the third extruder 20, the fourth extruder 21, or the like is not necessary, it is obvious that they can be suitably omitted.

### Configuration of Sensor Unit 16

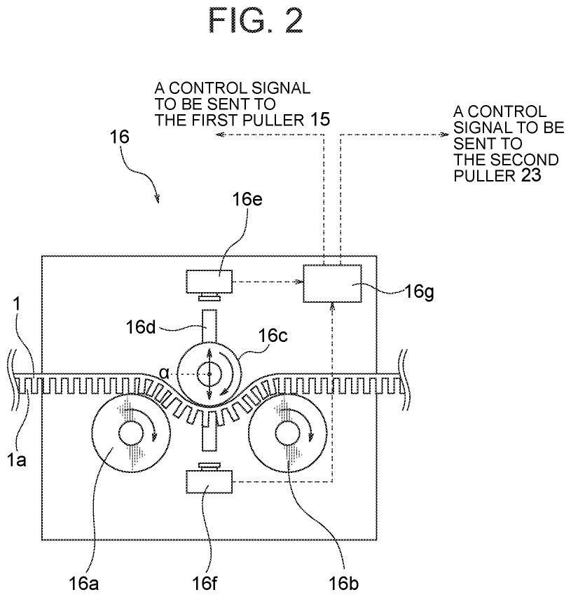

FIG. 2 illustrates an example of the configuration of the sensor unit 16 illustrated in FIG. 1.

As illustrated in FIG. 1, the sensor unit 16 is provided between the first puller 15 and the second puller 23 so as to be located upstream of (so as to precede) the heater 17 and the second die 18 and so as to be located downstream of (so as to follow) the first puller 15. The sensor unit 16 monitors the tension in the core member 1 in which grooves 1a have been formed at desired intervals in a continuous manner and sends a control signal to at least one of the first puller 15 and the second puller 23, so that at least one of the first puller 15 and the second puller 23 adjusts its pulling speed such that the tension in the core member 1 between the first puller 15 and the second puller 23 falls within a normal range. As illustrated in FIG. 2, the sensor unit 16 includes core-member feeding rollers 16a and 16b, a vertically-movable tension-applying roller 16c, a vertically-movable body 16d, an upper contact sensor 16e, a lower contact sensor 16f, a pulling-speed control unit 16g, and so forth.

The core-member feeding rollers 16a and 16b are rollers that transversely feed the core members 1 and 1′ and are arranged with at least a gap formed therebetween in a direction in which the core members 1 and 1′ are moved, the gap being equal to or larger than the outer diameter of the vertically-movable tension-applying roller 16c.

The vertically-movable tension-applying roller 16c is a roller that is rotatably supported on the vertically-movable body 16d, which is provided so as to be capable of moving up and down, and applies tension, by using its own weight and the weight of the vertically-movable body 16d, to the core members 1 and 1′ between the core-member feeding rollers 16a and 16b in a direction in which the core members 1 and 1′ can be easily bent.

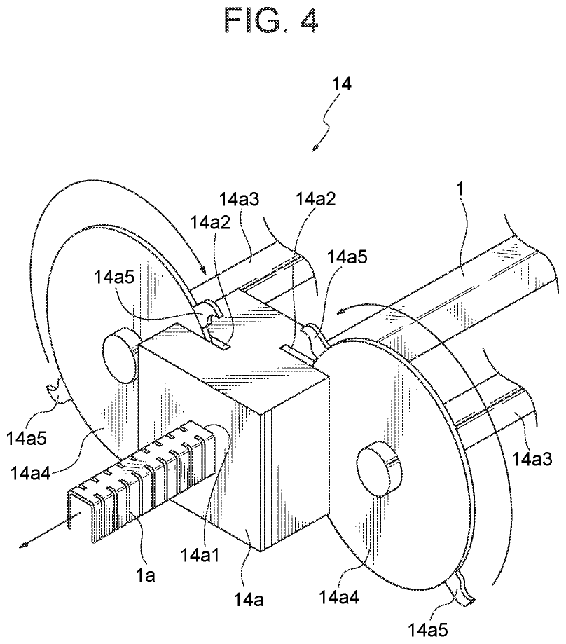

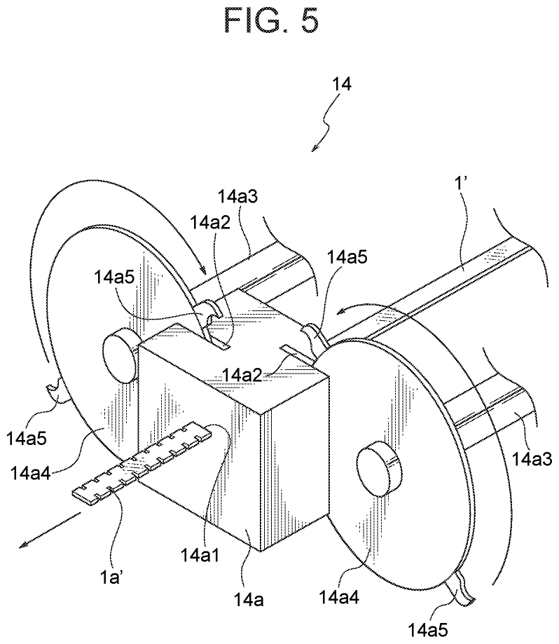

More specifically, in the case of the core member 1 that has a substantially inverted U-shape when viewed in cross section and two side surfaces in which the grooves 1a have been formed as illustrated in FIG. 4, if the grooves 1a are not formed in the core member 1, the core member 1 is not easily bent in the vertical direction. However, since the grooves 1a are formed in the two side surfaces of the core member 1, the core member 1 can be easily bent in the vertical direction in FIG. 4. In addition, in the case of the core member 1′ that is made of a synthetic resin and that has a substantially I-shape when viewed in cross section and two side surfaces in which grooves 1a′ have been formed as illustrated in FIG. 5, the core member 1′ can be easily bent in the vertical direction, which is the thickness direction of the core member 1′, with or without the grooves 1a′. Thus, each of the core members 1 and 1′ is put into the sensor unit 16 such that the direction in which the core members 1 and 1′ can be easily bent becomes parallel to the vertical direction and caused to pass over the core-member feeding rollers 16a and 16b. Then, tension is applied to the upper surface of each of the core members 1 and 1′ from above by using the weight of the vertically-movable tension-applying roller 16c and the weight of the vertically-movable body 16d between the core-member feeding rollers 16a and 16b.

The vertically-movable body 16d is a slider or the like that supports the vertically-movable tension-applying roller 16c such that the vertically-movable tension-applying roller 16c is rotatable and that is provided in the sensor unit 16 via a linear guide (not illustrated) or the like so as to be capable of moving up and down. Note that the ease with which the core members 1 and 1′ can be bent varies depending on the shapes, the thicknesses, and so forth of the core members 1 and 1′, and thus, it is preferable to provide weights or the like on the vertically-movable tension-applying roller 16c and the vertically-movable body 16d in accordance with the tension applied to each of the core members 1 and 1′ so as to adjust the tension applied to each of the core members 1 and 1′.

The upper contact sensor 16e and the lower contact sensor 16f are each a contact sensor such as an on-off switch that detects the vertically-movable body 16d being in contact therewith, the vertically-movable body 16d supporting the vertically-movable tension-applying roller 16c that applies tension to the core member 1 passing between the core-member feeding rollers 16a and 16b.

The pulling-speed control unit 16g is a control unit that receives a sensor output from the upper contact sensor 16e upon contact of the vertically-movable body 16d with the upper contact sensor 16e and a sensor output from the lower contact sensor 16f upon contact of the vertically-movable body 16d with the lower contact sensor 16f and outputs a pulling-speed adjustment command to at least one of the first puller 15 and the second puller 23 so as to adjust at least one of a first pulling speed of the first puller 15 and a second pulling speed of the second puller 23, so that the tension in the core member 1 between the first puller 15 and the second puller 23 falls within the normal range.

### Method of Manufacturing Extrusion Molded Product According to Embodiment

The method of manufacturing an extrusion molded product according to the embodiment of the present invention in which the sensor unit 16, which is configured in the manner described above, is newly provided in a part of the manufacturing process will now be described.

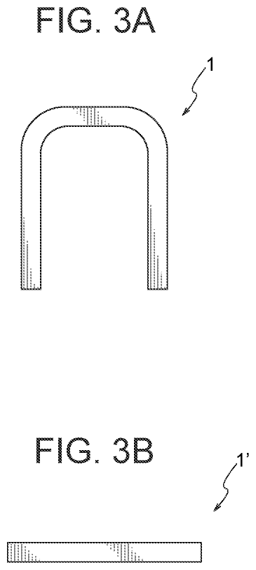

As illustrated in FIG. 1, in the method of manufacturing an extrusion molded product according to the embodiment of the present invention, a thermoplastic resin injected into the first extruder 11 is molded into a desired shape in the first die 12, that is, formed as the core member 1 made of a synthetic resin and having a substantially inverted U-shape when viewed in cross section as illustrated in FIG. 3A or the core member 1′ made of a synthetic resin and having a substantially I-shape when viewed in cross section as illustrated in FIG. 3B and cooled in the first cooling tank 13 while its shape is controlled by a first cooling sizer 13a so as to correspond to the most suitable shape for an extrusion molded product such as a weather strip, a trim, or a seal component that is mounted onto an automobile, a two-wheeled vehicle, an outboard motor, or the like.

Note that, as the synthetic resin used for the core member 1, for example, an olefin-based resin such as polypropylene having a type A durometer hardness (Shore A) of 85 or more or a mixed synthetic resin obtained by mixing 20% by weight to 50% by weight of talc powder or wollastonite powder into the olefin-based resin is used. However, the present invention is not particularly limited to these.

The core members 1 and 1′ each of which has been cooled by passing through the first cooling tank 13 and each of which has a desired shape is pulled by the first puller 15 at the first pulling speed and sent to the cutting mechanism unit 14.

In the cutting mechanism unit 14, grooves are formed in the core members 1 and 1′ by a plurality of cutting blades 14a5 of rotary bodies 14a4 that are caused to rotate by rotary shafts 14a3 arranged on the left and right sides of a holder 14a as illustrated in FIG. 4 and FIG. 5. In the case of the core member 1 made of a synthetic resin and having a substantially inverted U-shape when viewed in cross section, as illustrated in FIG. 4, the grooves 1a are formed on the left and right sides of the core member 1 at desired intervals in a continuous manner. In the case of the core member 1′ made of a synthetic resin and having a substantially I-shape when viewed in cross section, as illustrated in FIG. 5, the grooves 1a′ are formed on the left and right sides of the core member P′ at desired intervals in a continuous manner.

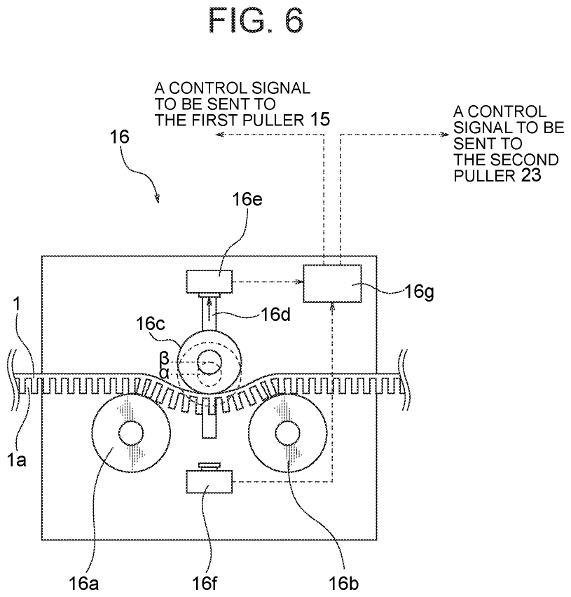

Thus, the holder 14a of the cutting mechanism unit 14 has a core-member passage hole 14a1 formed so as to correspond to the cross-sectional shape of the core member 1 that has a substantially inverted U-shape when viewed in cross section as illustrated in FIG. 3A or the cross-sectional shape of the core member 1′ that has a substantially I-shape when viewed in cross section as illustrated in FIG. 3B, and as illustrated in FIG. 4 and FIG. 5, slits 14b and 14b are formed in the holder 14a so as to be located on the left side and the right side of the holder 14a, respectively, and so as to be offset with respect to each other, that is, displaced from each other, in the longitudinal direction of the core member 1. The slits 14b and 14b extend to the core-member passage hole 14a1 and allow the rotary bodies 14a4 and the plurality of cutting blades 14a5 to pass therethrough. Note that, in the following description that refers to FIG. 6 and the subsequent drawings, although the core member 1 will be described as a representative example for convenience of description, the same applies to the core member 1′.

The core member 1 in which the grooves 1a have been formed at desired intervals by the cutting mechanism unit 14 is pulled by the first puller 15 at the first pulling speed and sent to the sensor unit 16.

In the sensor unit 16, as illustrated in FIG. 2, the vertically-movable tension-applying roller 16c is located between the core-member feeding rollers 16a and 16b. The core member 1 sequentially passes the core-member feeding roller 16a, the vertically-movable tension-applying roller 16c, and the core-member feeding roller 16b in the sensor unit 16 and is sent to the second die 18 via the heater 17. In this case, tension is applied to the core member 1 by using, for example, the weight of the vertically-movable tension-applying roller 16c and the weight of the vertically-movable body 16d from the upper surface side of the core member 1.

Here, since the vertically-movable body 16d, which supports the vertically-movable tension-applying roller 16c such that the vertically-movable tension-applying roller 16c is rotatable, is provided so as to be capable of moving up and down, when the tension generated in the core member 1 between the first puller 15 and the second puller 23 becomes large, the vertically-movable tension-applying roller 16c and the vertically-movable body 16d move upward. In contrast, when the tension in the core member 1 becomes small, the vertically-movable tension-applying roller 16c and the vertically-movable body 16d move downward.

A reference position α, an upper limit position β, and a lower limit position γ are set for the height of the vertically-movable tension-applying roller 16c, and the vertically-movable tension-applying roller 16c and the vertically-movable body 16d move up and down within the range. The upper contact sensor 16e detects the height of the vertically-movable tension-applying roller 16c reaching the upper limit position β, and the lower contact sensor 16f detects the height of the vertically-movable tension-applying roller 16c reaching the lower limit position γ. The pulling-speed control unit 16g optimally adjusts the difference between the first pulling speed of the first puller 15 and the second pulling speed of the second puller 23.

### When Tension in Core Member 1 Between First Puller 15 and Second Puller 23 is Appropriate

When the tension in the core member 1 between the first puller 15 and the second puller 23 is appropriate, the weights of the vertically-movable tension-applying roller 16c, the vertically-movable body 16d supporting the vertically-movable tension-applying roller 16c, and the like and the tension in the core member 1 are in balance. Thus, as illustrated in FIG. 2, the vertically-movable tension-applying roller 16c does not move in the vertical direction or slightly moves in the vertical direction such that the center of the vertically-movable tension-applying roller 16c is located near the reference position α, and the vertically-movable body 16d does not come into contact with either the upper contact sensor 16e or the lower contact sensor 16f.

Thus, in this case, a sensor output is not output by either the upper contact sensor 16e or the lower contact sensor 16f to the pulling-speed control unit 16g, and the pulling-speed control unit 16g does not output the pulling-speed adjustment command to either the first puller 15 or the second puller 23, so that the first puller 15 and the second puller 23 pull the core member 1 without changing their pulling speeds.

### When Tension in Core Member 1 Between First Puller 15 and Second Puller 23 Exceeds Appropriate Range

(When the Tension in the Core Member 1 Between the First Puller 15 and the Second Puller 23 Becomes Greater than a Reference Value)

When the tension in the core member 1 between the first puller 15 and the second puller 23 becomes greater than a reference value, the vertically-movable tension-applying roller 16c and the vertically-movable body 16d supporting the vertically-movable tension-applying roller 16c move upward, and the position of the center of the vertically-movable tension-applying roller 16c moves upward from the reference position α. When the tension in the core member 1 exceeds an appropriate range and the position of the center of the vertically-movable tension-applying roller 16c reaches the upper limit position β, as illustrated in FIG. 6, an upper end portion of the vertically-movable body 16d comes into contact with the upper contact sensor 16e.

Then, the upper contact sensor 16e outputs a sensor output to the pulling-speed control unit 16g, and the pulling-speed control unit 16g transmits an acceleration command for increasing the first pulling speed to the first puller 15 or transmits a deceleration command for reducing the second pulling speed to the second puller 23.

As a result, at least one of the first pulling speed of the first puller 15 and the second pulling speed of the second puller 23 is adjusted, and the tension in the core member 1 between the first puller 15 and the second puller 23 falls within the normal range. Then, the vertically-movable tension-applying roller 16c moves downward, and the upper end portion of the vertically-movable body 16d moves away from the upper contact sensor 16e and returns to a position near the reference position α as illustrated in FIG. 2. The pulling-speed control unit 16g does not output a speed change command to either the first puller 15 or the second puller 23.

### When Tension in Core Member 1 Between First Puller 15 and Second Puller 23 Fall Below Appropriate Range

(When the Tension in the Core Member 1 Between the First Puller 15 and the Second Puller 23 Becomes Less than the Reference Value)

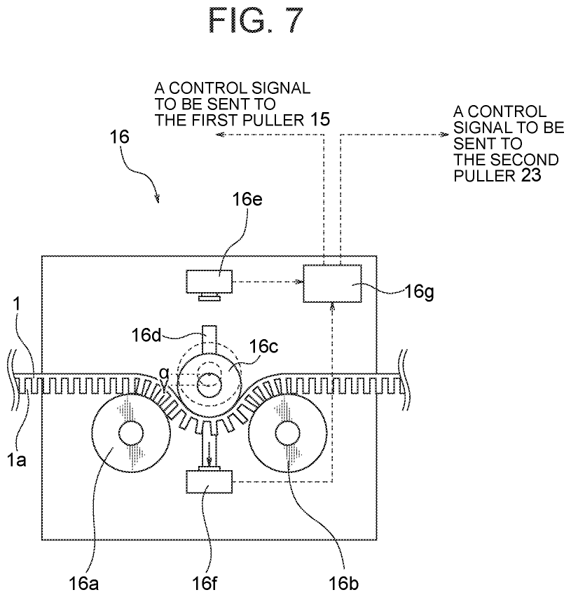

When the tension in the core member 1 between the first puller 15 and the second puller 23 becomes less than the reference value, the core member 1 loosens between the first puller 15 and the second puller 23, and the position of the center of the vertically-movable tension-applying roller 16c moves downward from the reference position α as illustrated in FIG. 7. When the tension in the core member 1 falls below the appropriate range and the position of the center of the vertically-movable tension-applying roller 16c reaches the lower limit position γ, a lower end portion of [symbol] the vertically-movable body 16d comes into contact with the lower contact sensor 16f.

Then, the lower contact sensor 16f outputs a sensor output to the pulling-speed control unit 16g, and the pulling-speed control unit 16g transmits a deceleration command for reducing the first pulling speed to the first puller 15 or transmits an acceleration command for increasing the second pulling speed to the second puller 23. As a result, at least one of the first pulling speed of the first puller 15 and the second pulling speed of the second puller 23 is adjusted, and the tension in the core member 1 between the first puller 15 and the second puller 23 falls within the normal range.

As a result, the vertically-movable tension-applying roller 16c moves upward, and the lower end portion of the vertically-movable body 16d moves away from the lower contact sensor 16f and returns to a position near the reference position α as illustrated in FIG. 2. The pulling-speed control unit 16g does not output a speed change command to either the first puller 15 or the second puller 23.

Here, while the first puller 15 is pulling the core member 1, the operation of the second puller 23 cannot be stopped due to the characteristics of extrusion molding, and while the second puller 23 is pulling the core member 1, the operation of the first puller 15 cannot be stopped due to the characteristics of extrusion molding. In other words, once manufacture of an extrusion molded product has been started, the first puller 15 and the second puller 23 continuously pull the core member 1 or an extrusion molded product 10 without stopping. In addition, changes in the pulling speeds of the first puller 15 and the second puller 23 affect the quality of the extrusion molded product 10, and thus, each of the pulling speeds cannot be controlled at an unlimited speed.

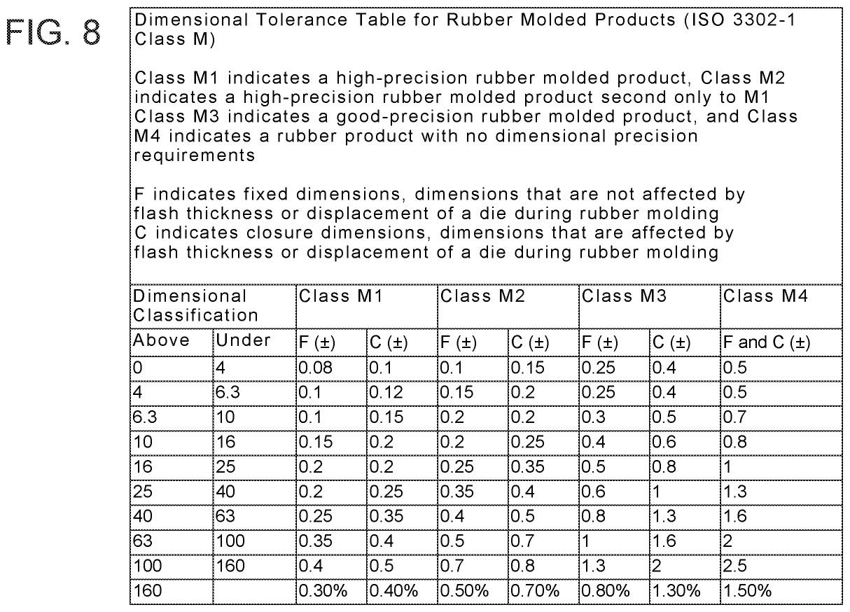

FIG. 8 illustrates the “dimensional tolerance table for molded rubber products (ISO 3302-1 Class M)”, which is a table often used as a standard for evaluating molding dimensions of extrusion molded products made of a thermoplastic resin.

In the table illustrated in FIG. 8, in the cases of dimensional classifications [above 0 and under 4] and [above 4 and under 6.3], the tolerance of a Class M4 rubber product with respect to a reference dimension, which is 4, is ±0.5, that is, the tolerance has a minimum value of 3.5 and a maximum value of 4.5. The acceptable range of variations is within (±0.5/4)×100=±12.5%.

The accuracy with which the extrusion molded product 10 is molded is correlated with the molding speed, and the cross-section of a molded product increases or decreases in proportion to a molding speed. For these reasons, when the tolerance of Class M4 is set to the maximum variation, it is necessary to control the speed difference between the two pullers 15 and 23 to be 12.5% or lower without stopping their pulling operations so as to synchronize the pulling speed of the first puller 15 with the pulling speed of the second puller 23.

Consequently, when the pulling-speed control unit 16g of the sensor unit 16 controls the second pulling speed, which is the pulling speed of the second puller 23, the pulling-speed control unit 16g performs control, without stopping the pulling operation, such that the upper limit speed of the second pulling speed is 12.5% or less of the first pulling speed, which is the pulling speed of the first puller 15, and such that the lower limit speed of the second pulling speed is within ±12.5% of the first pulling speed. When the pulling-speed control unit 16g of the sensor unit 16 controls the pulling speed of the first puller 15, the pulling-speed control unit 16g performs control, without stopping the pulling operation, such that the upper limit speed of the first pulling speed is 12.5% or less of the second pulling speed and such that the lower limit speed of the first pulling speed is within ±12.5% of the second pulling speed. In addition, also in the case of synchronizing the pulling speeds by sending commands to both the first puller 15 and the second puller 23, the speed difference between the two pullers 15 and 23 is controlled to be 12.5% or lower without stopping the pulling operations of the two pullers 15 and 23.

Note that, in the method of manufacturing an extrusion molded product according to the embodiment of the present invention, although control is performed such that the speed difference between the upper limit speed of the pulling speed of the first puller 15 and the upper limit speed of the pulling speed of the second puller 23 is 12.5% or lower and such that the speed difference between the lower limit speed of the pulling speed of the first puller 15 and the lower limit speed of the pulling speed of the second puller 23 is 12.5% or lower, it is more preferable to control both the speed difference between the upper limit speeds and the speed difference between the lower limit speeds to be 4% or lower. When speed control of 4% or lower is performed on both the high-speed side and the low-speed side, regarding the extrusion molded product 10 that is manufactured, the range of variations in molding dimensions is reduced, and the accuracy of product dimensions can be further improved compared with the case where the speed difference is 12.5% or lower.

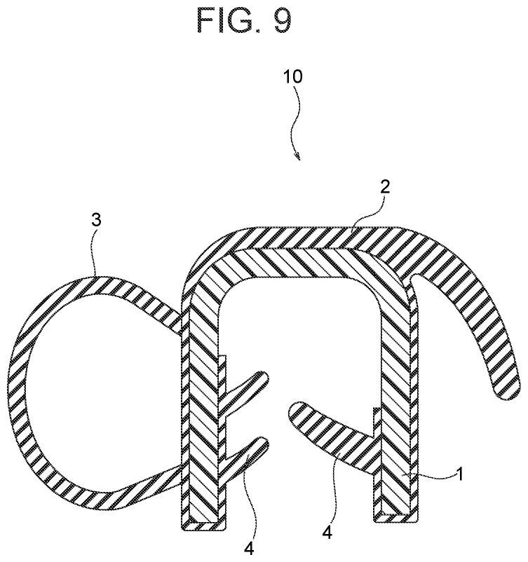

The grooves 1a are formed in the core member 1 at desired intervals in a continuous manner so as to have a desired shape by the cutting blades 14a5, which are rotating on the left and right sides, while the core member 1 passes through the holder 14a, and after that, the core member 1 is heated by the heater 17 as necessary and enters the second die 18 as illustrated in FIG. 1. Then, covering portions such as a body seal lip portion 2, a hollow seal portion 3, and glass seal lip portions 4 are formed on the outer periphery of the core member 1 by using the thermoplastic elastomer extruded from the second extruder 19 to the fourth extruder 21, so that the extrusion molded product 10 configured as illustrated in FIG. 9 is extrusion-molded.

Here, as the synthetic resin used for the core member 1, for example, an olefin-based resin such as polypropylene having a type A durometer hardness (Shore A) of 85 or more or a mixed synthetic resin obtained by mixing 20% by weight to 50% by weight of talc powder or wollastonite powder into the olefin-based resin is used. However, the present invention is not particularly limited to these.

In addition, as the thermoplastic elastomer used for forming the covering portions such as the body seal lip portion 2, the hollow seal portion 3, and the glass seal lip portions 4, a thermoplastic elastomer that contains an olefin-based resin having a type A durometer hardness (Shore A) of 40 to 80 is used. As a soft thermoplastic elastomer used for the hollow seal portion 3, a thermoplastic elastomer that contains an olefin-based resin having a type A durometer hardness (Shore A) of 20 to 40 is used.

The extrusion molded product 10 that has been provided with the covering portions in the second die 18 is sent to the second cooling tank 22. In the second cooling tank 22, the extrusion molded product 10 passes through a second cooling sizer 22a, which is provided in the second cooling tank 22, as necessary and pulled by the second puller 23. After passing through the second puller 23, the extrusion molded product 10 is cut by the cutter 24 so as to have a predetermined length.

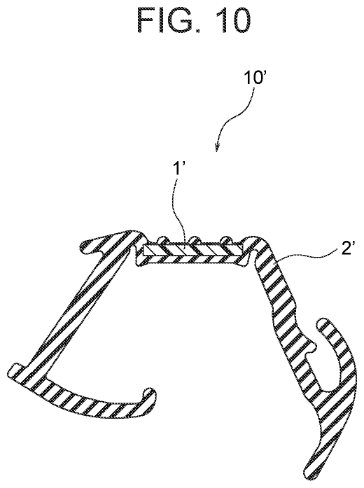

FIG. 9 is a diagram illustrating an example of a cross-sectional view of the extrusion molded product 10 that is a weather strip manufactured by the method of manufacturing an extrusion molded product according to the embodiment, and FIG. 10 is a diagram illustrating an example of a cross-sectional view of an extrusion molded product 10′ that is a weather strip manufactured by the method of manufacturing an extrusion molded product according to the embodiment.

In the extrusion molded product 10 illustrated in FIG. 9, the grooves 1a such as those illustrated in FIG. 4 are formed on the left and right side of the core member 1, which is made of a synthetic resin, which has a substantially inverted U-shape when viewed in cross section, and which is illustrated in FIG. 3A. In addition, the body seal lip portion 2 made of a thermoplastic elastomer is formed over the outer periphery of the core member 1 by the second extruder 19, and the hollow seal portion 3 made of a soft thermoplastic elastomer is extrusion-molded on the outer side of the body seal lip portion 2 by the third extruder 20. The glass seal lip portions 4 to be mounted onto a flange of a vehicle body of an automobile is formed on the inner side of the core member 1 by the fourth extruder 21.

In the extrusion molded product 10′ illustrated in FIG. 10, the grooves 1a′ such as those illustrated in FIG. 5 are formed on the left and right side of the core member 1′, which is made of a synthetic resin, which has a substantially I-shape when viewed in cross section, and which is illustrated in FIG. 3B. In addition, a covering portion 2′ that is made of a thermoplastic elastomer is formed over the outer periphery of the core member 1′.

In the case of further adding a thermoplastic elastomer or a synthetic resin of different material to the extrusion molded products 10 and 10′, a fifth extruder, a sixth extruder, and the like are added in a manner similar to the second extruder 19, the third extruder 20, and the fourth extruder 21 that are illustrated in FIG. 1, and co-extrusion molding is performed inside the second die 18.

### Summary of Method of Manufacturing Extrusion Molded Product According to Embodiment of Present Invention

As described above, in the method of manufacturing an extrusion molded product according to the present invention, the sensor unit 16 that monitors the tension in the core member 1 is provided between the first puller 15 and the second puller 23, the sensor unit 16 adjusts, on the basis of the tension in the core member 1 monitored by the sensor unit 16, at least one of the pulling speed of the first puller 15 and the pulling speed of the second puller 23 such that the tension in the core member 1 between the first puller 15 and the second puller 23 falls within the normal range.

Consequently, the tension in the core member 1 between the first puller 15 and the second puller 23 falls within the normal range, and formation of slack in the core member 1 or overextension of the core member 1 will not occur. Therefore, even when the extrusion molded products 10 and 10′, in which covering portions such as a body seal lip portion, a glass seal lip portion, and a hollow seal portion have been formed on the core members 1 and 1′ by the second extruder 19, the third extruder 20, the fourth extruder 21, and the like, are manufactured in the second die 18, the extrusion molded products 10 and 10′ each having a favorable quality and constant molding accuracy can be consistently manufactured.

In the method of manufacturing an extrusion molded product according to the embodiment of the present invention, the sensor unit 16 includes the core-member feeding rollers 16a and 16b that are arranged between the first puller 15 and the second puller 23 with a gap formed therebetween in the direction in which the core member 1 is moved and the vertically-movable tension-applying roller 16c that is provided between the core-member feeding rollers 16a and 16b so to be capable of moving up and down and that applies tension to each of the core members 1 and 1′, and the sensor unit 16 monitors the tension in each of the core members 1 and 1′ on the basis of the height of the vertically-movable tension-applying roller 16c.

Accordingly, such a simple configuration enables the sensor unit 16 to apply tension to the core members 1 and 1′, and thus, the extrusion molded products 10 and 10′ each having a favorable quality and constant molding accuracy can be consistently manufactured without increasing the manufacturing costs.

In the method of manufacturing an extrusion molded product according to the embodiment of the present invention, the cutting mechanism unit 14 that cuts the core members 1 and 1′ so as to form the grooves 1a and 1a′ by using the cutting blades 14a5 is provided between the first die 12 and the first puller 15, and the sensor unit 16 applies tension to the core members 1 and 1′, in which the grooves 1a and 1a′ have been formed by the cutting mechanism unit 14, in the direction in which the core members 1 and 1′ can be easily bent.

Thus, when the core members 1 and 1′ can be easily bent as a result of forming the grooves 1a and 1a′ therein, the pulling speeds are adjusted by applying tension to the core members 1 and 1′ in the direction in which the core members 1 and 1′ can be easily bent such that the tension in each of the core members 1 and 1′ falls within the normal range. Thus, the tension in each of the core members 1 and 1′ can be adjusted to fall within a further normal range, and the extrusion molded products 10 and 10′ each having a favorable quality and more constant molding accuracy can be consistently manufactured.

In the method of manufacturing an extrusion molded product according to the embodiment of the present invention, the sensor unit 16 includes the upper contact sensor 16e that is provided above the vertically-movable tension-applying roller 16c and that detects how close the vertically-movable tension-applying roller 16c is thereto and the lower contact sensor 16f that is provided below the vertically-movable tension-applying roller 16c and that detects how close the vertically-movable tension-applying roller 16c is thereto, and the sensor unit 16 monitors the tension in the core member 1 on the basis of detection outputs of the upper contact sensor 16e and the lower contact sensor 16f. The pulling-speed control unit 16g sends a command to at least one of the first puller 15 and the second puller 23 on the basis of sensor outputs of the upper contact sensor 16e and the lower contact sensor 16f so as to eliminate the speed difference between the first puller 15 and the second puller 23.

Accordingly, the tension applied to each of the core members 1 and 1′ reaching the upper limit position β or the lower limit position γ can be detected with a simple configuration between the first puller 15 and the second puller 23, and thus, the extrusion molded products 10 and 10′ each having a favorable quality and constant molding accuracy can be consistently manufactured without increasing the manufacturing costs.

In the method of manufacturing an extrusion molded product according to the embodiment of the present invention, the second puller 23 performs, on the basis of the tension in each of the core members 1 and 1′ monitored by the sensor unit 16, the pulling operation at a pulling speed with an upper limit speed and a lower limit speed each of which is within ±12.5% of the pulling speed of the first puller 15 without stopping, or the first puller 15 performs the pulling operation at a pulling speed with an upper limit speed that is 12.5% or less of the pulling speed of the second puller 23 and a lower limit speed that is within ±12.5% of the pulling speed of the second puller 23 without stopping.

Accordingly, even if there is a speed difference (variations) between the first puller 15 and the second puller 23, the acceptable range of variations is within (±0.5/4)×100=±12.5%, and the tolerance of a Class M4 rubber product with respect to a reference dimension, which is 4, is ±0.5, that is, the tolerance has a minimum value of 3.5 and a maximum value of 4.5. Thus, from this point of view as well, the extrusion molded products 10 and 10′ each having a favorable quality and constant molding accuracy can be consistently manufactured.

In particular, the accuracy with which each of the extrusion molded products 10 and 10′ is molded is correlated with the molding speed, and the cross-section of a molded product increases or decreases in proportion to a molding speed. When the tolerance of Class M4, which is +0.5, is set to the maximum variation, although it is necessary to control the speed difference between the two pullers 15 and 23 to be 12.5% or lower so as to synchronize the pulling speed of the first puller 15 with the pulling speed of the second puller 23, the extrusion molded products 10 and 10′ each having a favorable quality and constant molding accuracy can be consistently manufactured.

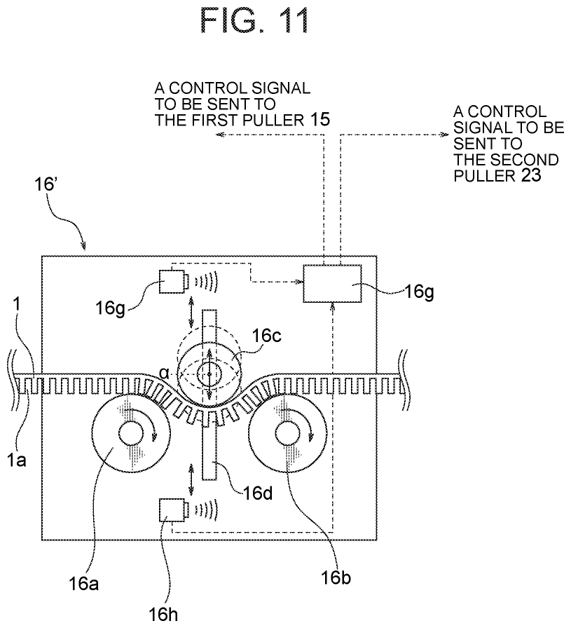

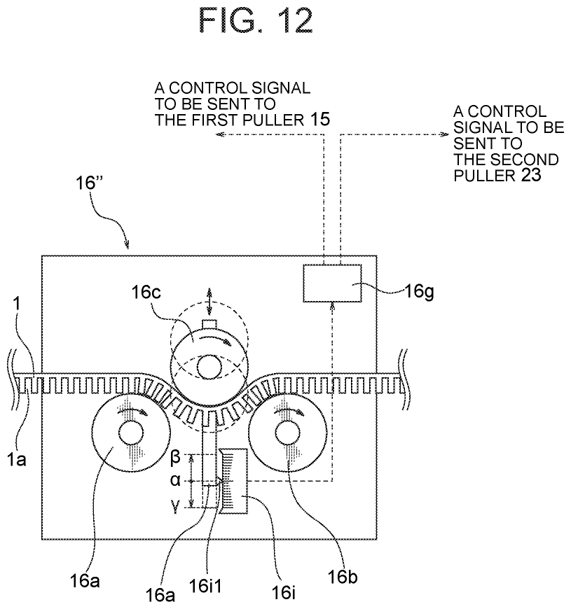

Note that, in the above description of the embodiment, although the sensor unit 16 detects the vertically-movable tension-applying roller 16c that applies tension to the core member 1 reaching the upper limit position β when the upper end portion of the vertically-movable body 16d comes into contact with the upper contact sensor 16e and detects the vertically-movable tension-applying roller 16c reaching the lower limit position γ when the lower end portion of the vertically-movable body 16d comes into contact with the lower contact sensor 16f as illustrated in FIG. 2, FIG. 6, and FIG. 7, the present invention is not limited to this. For example, as illustrated in FIG. 11, the upper end portion and the lower end portion of the vertically-movable body 16d may be detected by an upper optical (non-contact) sensor 16g and a lower optical (non-contact) sensor 16h, respectively. Alternatively, as illustrated in FIG. 12, for example, a wiper 16i1 of a potentiometer 16i, which is a variable resistance sensor, may be attached to the vertically-movable body 16d, and the potentiometer 16i may detect the vertically-movable tension-applying roller 16c reaching the upper limit position β and the lower limit position γ.

In addition, in the above description of the embodiment, although the grooves 1a are formed in the core member 1 by the cutting mechanism unit 14, and the grooves 1a′ are formed in the core member 1′ by the cutting mechanism unit 14, the present invention is not limited to this. The present invention is also applicable when an extrusion molded product is molded without forming any grooves in a core member. For example, the core member 1′ that has a substantially I-shape (a flat plate-like shape) when viewed in cross section and that is illustrated in FIG. 3B has flexibility in one direction, which is the thickness direction thereof. Thus, there is a case where the grooves 1a′ are not necessary, and in this case, the present invention is applied by using the core member 1′ without forming the grooves 1a′. In the case of not forming a groove in a core member, the cutting mechanism unit 14 may be omitted. Alternatively, the cutting mechanism unit 14 may be provided as described above, and a core member may be allowed to pass through the cutting mechanism unit 14 while not causing the rotary bodies 14a4 to rotate so that the core member is ejected from the holder 14a without forming any grooves therein by the cutting blades 14a5.

1. A method of manufacturing an extrusion molded product, the method comprising:
a step of pulling a core member by a first puller, the core member being made of a resin and molded into a desired shape in a first die; and
a step of molding an extrusion molded product by providing a covering portion made of a thermoplastic elastomer over an outer periphery of the core member, which has been pulled by the first puller, in a second die and pulling the extrusion molded product by a second puller,
wherein a sensor unit that monitors tension in the core member is provided between the first puller and the second puller, and at least one of the first puller and the second puller adjusts, based on the tension in the core member monitored by the sensor unit, a pulling speed such that the tension in the core member between the first puller and the second puller falls within a normal range.

2. The method of manufacturing the extrusion molded product according to claim 1,
wherein the sensor unit includes core-member feeding rollers that are arranged between the first puller and the second puller with a gap formed between the core-member feeding rollers in a direction in which the core member is moved and a vertically-movable tension-applying roller that is provided between the core-member feeding rollers in such a manner as to be capable of moving up and down and that applies tension to the core member, and the sensor unit monitors the tension in the core member based on a height of the vertically-movable tension-applying roller.

3. The method of manufacturing the extrusion molded product according to claim 2,
wherein a cutting mechanism unit that cuts the core member in such a manner as to form a groove by using a cutting blade is provided between the first die and the first puller, and
wherein the sensor unit applies tension to the core member, in which the groove has been formed by the cutting mechanism unit, in a direction in which the core member is easily bent.

4. The method of manufacturing the extrusion molded product according to any one of claim 1,
wherein the second puller pulls, based on the tension in the core member monitored by the sensor unit, the extrusion molded product at a pulling speed with an upper limit speed and a lower limit speed each of which is within ±12.5% of a pulling speed of the first puller without stopping.

5. The method of manufacturing the extrusion molded product according to claim 1,
wherein the first puller pulls, based on the tension in the core member monitored by the sensor unit, the core member at a pulling speed with an upper limit speed and a lower limit speed each of which is within +12.5% of a pulling speed of the second puller without stopping.
